(19) United States
(12) Patent Application Publication
(10) Pub. No.: US 2024/0128532 A1
(43) Pub. Date: Apr. 18, 2024

(54) STRUCTURAL SIDE THERMAL COMPONENTS

(71) Applicant: Rivian IP Holdings, LLC, Plymouth, MI (US)

(72) Inventors: Matthew Quinn Pruett, Long Beach, CA (US); Rafael Lujan, Huntington Beach, CA (US); Johannes Wilhelmus Elisabeth Bernards, Sunbury-on-Thames (GB); Najmeh Rahimi, Lake Forest, CA (US); Daniel Ochoa, Fullerton, CA (US)

(21) Appl. No.: 18/046,653

(22) Filed: Oct. 14, 2022

(51) Int. Cl. H01M 10/613; B60K 1/04; B60L 50/60; H01M 10/625; H01M 10/647; H01M 10/6554; H01M 10/6556; H01M 50/209; H01M 50/249; H01M 50/291

(52) U.S. Cl. CPC H01M 10/613; B60K 1/04; B60L 50/66; H01M 10/625; H01M 10/647; H01M 10/6554; H01M 10/6556; H01M 50/209; H01M 50/249; H01M 50/291; B60K 2001/0438; H01M 2220/20

(57) ABSTRACT

An apparatus can include a thermal component. The thermal component can include a first side of the thermal component. The thermal component can include a second side of the thermal component. The first side of the thermal component can couple with a battery cell. The second side of the thermal component can couple with a structural member. The structural member can support the battery cell.

### INTRODUCTION

Electric vehicles (EVs) can be powered using batteries that store energy. The batteries can include different components facilitating energy storage.

### SUMMARY

Battery cells can supply electric power to the components electrically coupled with the battery cells. In providing electric current to the components, the battery cells can generate thermal energy and emit heat from the body of each battery cell into its surroundings. The solutions described herein can provide an apparatus for cooling and supporting the battery cells.

At least one aspect is directed to an apparatus. The apparatus can include a thermal component. The thermal component can include a first side of the thermal component. The thermal component can include a second side of the thermal component. The first side of the thermal component can couple with a battery cell. The second side of the thermal component can couple with a structural member. The structural member can support the battery cell.

At least one aspect is directed to a method. The method can include providing a thermal component. The thermal component can include a first side of the thermal component. The thermal component can include a second side of the thermal component. The method can include coupling the first side of the thermal component with a battery cell. The method can include coupling the second side of the thermal component with a structural member. The structural member can be configured to support the battery cell.

At least one aspect is directed to an electric vehicle. The electric vehicle can include a battery pack. The battery pack can power one or more components of the electric vehicle. The electric vehicle can include a battery cell disposed in the battery pack. The electric vehicle can include a thermal component. The thermal component can include a first side of the thermal component and a second side of the thermal component. The first side of the thermal component can couple with the battery cell. The electric vehicle can include a structural member. The structural member can couple with the second side of the thermal component. The structural member can support the battery cell.

At least one aspect is directed to an apparatus. The apparatus can include a thermal component. The thermal component can include a side of the thermal component. The side of the thermal component can couple with a sidewall of multiple battery cells.

At least one aspect is directed to a system. The system can include a battery cell. The battery can include a sidewall. The system can include a thermal component. The thermal component can include a first side of the thermal component and a second side of the thermal component. The first side of the thermal component can couple with the sidewall of the battery cell. The second side of the thermal component can include a mounting member. The mounting member can couple with a structural member. The structural member can support the battery cell.

At least one aspect is directed to an electric vehicle. The electric vehicle can include a battery cell disposed in a battery pack frame. The electric vehicle can include a thermal component. The thermal component can include a first side of the thermal component and a second side of the thermal component. The first side of the thermal component can couple with a sidewall of the battery cell. The electric vehicle can include a mounting member disposed on the second side of the thermal component. The electric vehicle can include a structural member. The structural member can couple with the mounting member. The electric vehicle can include a base member. The base member can couple with the structural member. The base member can be disposed a distance from a midline of the battery pack frame.

At least one aspect is directed to an apparatus. The apparatus can include a thermal component. The apparatus can include a first side of the thermal component. The first side of the thermal component can couple with a sidewall of a battery cell. The apparatus can include a second side of the thermal component. The second side of the thermal component can include a mounting member. The mounting member can couple with a structural member. The structural member can support the battery cell.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a cross-sectional view of an electric vehicle, according to an example implementation.

FIG. 2A depicts a battery pack, according to an example implementation.

FIG. 2B depicts a battery module, according to an example implementation.

FIG. 2C depicts a cross-sectional view of a battery cell, according to an example implementation.

FIG. 2D depicts a cross sectional view of a battery cell, according to an example implementation.

FIG. 2E depicts a cross sectional view of a battery cell, according to an example implementation.

FIG. 3 depicts a perspective view of an apparatus, according to an example implementation.

FIG. 4 depicts a perspective view of an apparatus, according to an example implementation.

FIG. 5 depicts a perspective view of an apparatus, according to an example implementation.

FIG. 6 depicts a perspective view of an apparatus, according to an example implementation.

FIG. 7 depicts a method of managing the temperature of battery cells and supporting the battery cells, according to an example implementation.

FIG. 8 depicts a method of providing an apparatus, according to an example implementation.

### DETAILED DESCRIPTION

Following below are more detailed descriptions of various concepts related to, and implementations of, methods, apparatuses, and systems of managing the temperature of battery cells and supporting the battery cells. The various concepts introduced above and discussed in greater detail below may be implemented in any of numerous ways.

The present disclosure is directed to systems and methods of managing the temperature of battery cells and supporting the battery cells. Battery cells can store electrical energy for one or more electrical components, such as electrical or electromechanical devices in an electric vehicle. During operation, the battery cells can supply electric power to the components electrically coupled with the battery cells. In providing electric current to the components, the battery cells can generate thermal energy and emit heat from the body of each battery cell into its surroundings. A thermal management system including one or more cold plates located underneath the battery cells can cool the battery cells, and can also be exposed to contact with other vehicle components or objects

Systems and method of the present technical solution can provide an apparatus for cooling and supporting the battery cells. The apparatus can include a thermal component (e.g., a cooling component or cold plate) that is located on the side of the battery cells. The thermal component can have one side that cools a sidewall of the battery cell and another side that has a mounting member. The mounting member can couple with a structural member that supports the battery cells. The mounting member can be disposed between a first structural member and a second structural member. The thermal component can have an inlet and an outlet that are fluidly coupled with a channel containing coolant.

The disclosed solutions have a technical advantage of combining thermal management with structural support of the battery cells. For example, the battery cells can be supported by the same component that provides thermal management and that supports the battery cells. Additionally, the thermal component being located on the side of the battery cells as opposed to the bottom of the battery cells can reduce or prevent coolant in the thermal component from leaking due to a bottom strike of the battery cells. To reduce the weight of the apparatus, the thermal component can provide structural support of the battery cells without the need for an additional structural component to support the battery cells. The reduction in weight can increase the range of an electric vehicle, which saves energy.

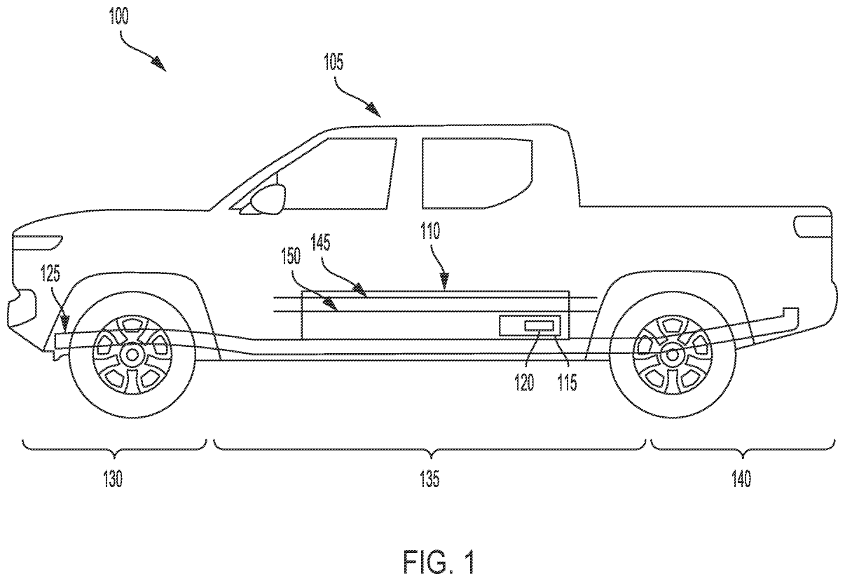

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

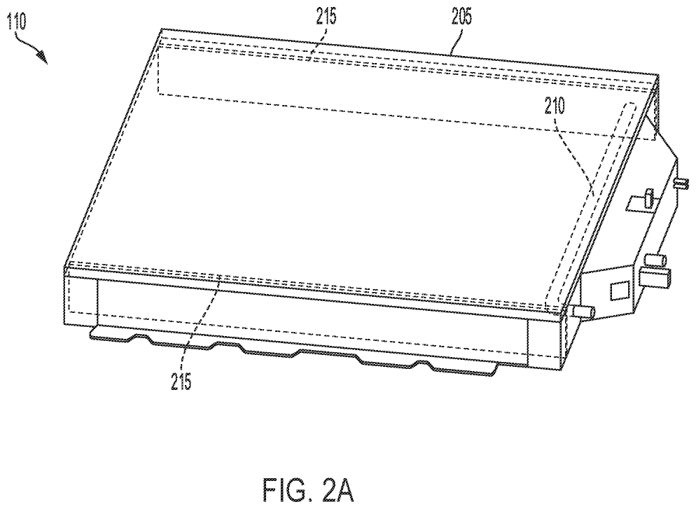

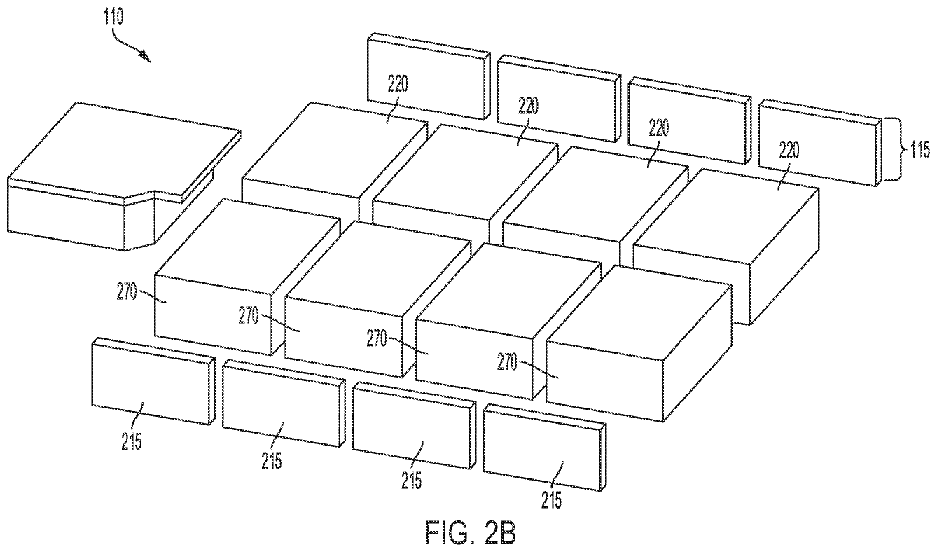

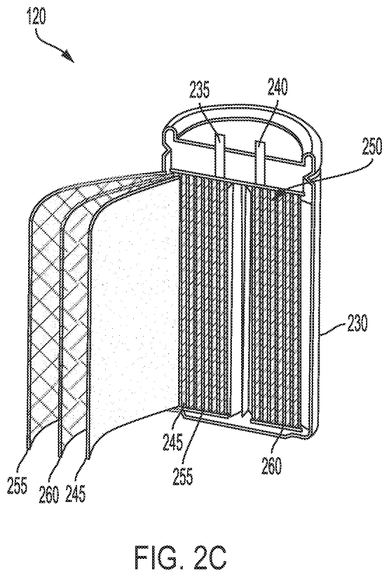

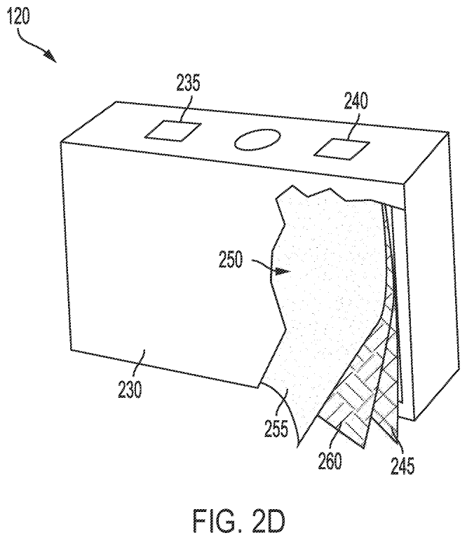

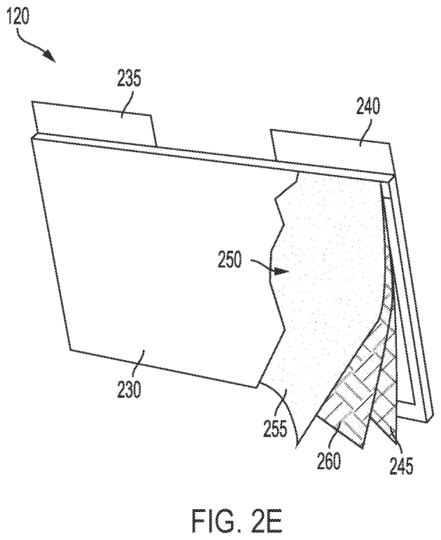

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can include one or more battery cells 120. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate, cooling component, etc.) 215. The thermal component 215 can be positioned in relation to a first side submodule and a second side submodule, such as in between the first side submodule and second side submodule, among other possibilities. The thermal component 215 can be positioned in relation to a submodule such as on a side of the submodule. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one side submodule 220. At least one thermal component 215 can be disposed on a side of the side submodule. For example, one thermal component 215 can be configured for heat exchange with one battery module 115. The thermal component 215 can be disposed or thermally coupled with the side submodule 220. One thermal component 215 can also be thermally coupled with more than one battery module 115 (or more than two submodules 220). The battery side submodule 220 can collectively form one battery module 115. In some examples each side submodule 220 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include the side submodule 220, possibly with a thermal component 215 located on a side of the side submodule 220. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also release lithium ions during the discharging of the battery cell 120. Conversely, the cathode layer 255 can receive electrical current into the battery cell 120 and can output electrons during the charging of the battery cell 120. The cathode layer 255 can receive lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example Lithium iron phosphate (LFP), Lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

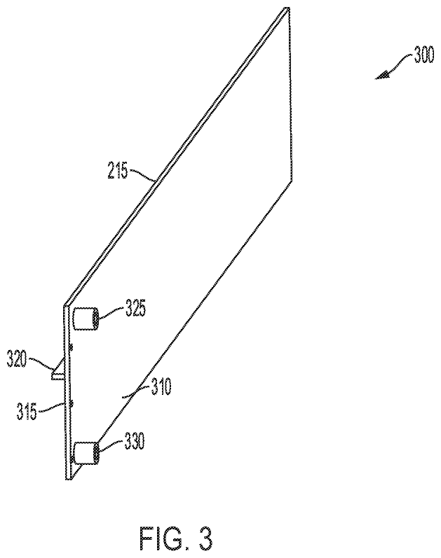

FIG. 3 depicts a perspective view of an apparatus 300. The apparatus 300 can include at least one thermal component 215 (e.g., cold plate, cooling component, etc.). The thermal component 215 can cool the battery cell 120. The thermal component 215 can cool the battery cell 120 (e.g., prismatic cell) in a cell-to-pack configuration. The thermal component 215 can heat the battery cell 120. The thermal component 215 can be flat or substantially flat. The thermal component 215 can have a variety of form factors, shapes, or sizes. The thermal component 215 can be positioned relative to a first battery cell 120 and a second battery cell 120. The first battery cell 120 can be disposed on a side of the second battery cell 120. The thermal component 215 can be positioned between the first battery cell 120 and the second battery cell 120. The first battery cell 120, the second battery cell 120, and the thermal component 215 can be positioned along a horizontal (e.g., lateral) axis or a vertical axis. The thermal component 215 can be disposed relative to a first battery module 115 and a second battery module 115. The first battery module 115 can be disposed on a side of the second battery module 115. The thermal component 215 can be position in between the first battery module 115 and the second battery module 115. The first battery module 115, the second battery module 115, and the thermal component 215 can be positioned along a horizontal axis or a vertical axis.

The thermal component 215 can include a first side 310. The first side 310 of the thermal component 215 can couple with at least one sidewall 270 of at least one battery cell 120. For example, the first side 310 of the thermal component 215 can couple with the sidewall 270 of multiple battery cells 120. The first side 310 of the thermal component 215 can interface with the sidewall 270 of multiple battery cells 120. The first side 310 of the thermal component 215 can interface with multiple sidewalls 270 of multiple battery cells 120. The first side 310 of the thermal component 215 can couple with the sidewall 270 of multiple battery cells 120 contained in the battery module 115. The first side 310 of the thermal component 215 can couple with the battery module 115. The first side 310 of the thermal component 215 can couple with a plurality of sidewalls of battery cells 120. The first side 310 of the thermal component 215 can be flat or substantially flat.

The first side 310 of the thermal component 215 can be disposed proximate the sidewall 270 of the battery cell 120. For example, the first side 310 of the thermal component 215 can be in contact with the sidewall 270 of the battery cell 120. The first side 310 of the thermal component 215 can be in contact with the sidewall 270 of the battery cell 120 to cool the battery cell 120. The first side 310 of the thermal component 215 can be close to or near the sidewall 270 of the battery cell 120. The first side 310 of the thermal component 215 can be disposed proximate the sidewall 270 of the battery module 115. For example, the first side 310 of the thermal component 215 can be in contact with the sidewall 270 of the battery module 115. The first side 310 of the thermal component 215 can be in contact with the sidewall 270 of the battery module 115 to cool the battery cell 120. The first side 310 of the thermal component 215 can be close to or near the sidewall 270 of the battery module 115.

The thermal component 215 can include a second side 315. The second side 315 of the thermal component 215 can be disposed opposite the first side 310 of the thermal component 215. For example, the second side 315 of the thermal component 215 can be located on a side of thermal component 215 that that is opposite the first side 310 of the thermal component 215. The second side 315 of the thermal component 215 can be flat or substantially flat. The second side 315 of the thermal component 215 can include a protrusion, depression, or recess. The second side 315 of the thermal component 215 can couple with the battery cell 120. The second side 315 of the thermal component 215 can contact the sidewall of the battery cell 120.

The second side 315 of the thermal component 215 can include a mounting member 320. The mounting member 320 can be disposed proximate a center of gravity of the battery cell 120. For example, the mounting member 320 can be positioned at the center of gravity of the battery cell 120. The mounting member 320 can be disposed between a top portion of the battery cell 120 and a bottom portion of the battery cell 120. The thermal component 215 and the mounting member 320 can be a unitary piece. For example, the thermal component 215 and the mounting member 320 can be made from a single piece of material. The mounting member 320 can be disposed along a midline of the thermal component 215. For example, the midline of the thermal component 215 can bisect the thermal component 215 into a top portion of the thermal component 215 and a bottom portion of the thermal component 215. The mounting member 320 can be positioned along the midline of the thermal component 215. The mounting member 320 can include a protrusion, depression, or recess. The mounting member 320 can be disposed along a portion of the thermal component 215.

The thermal component 215 can include a side of the thermal component (e.g., first side 310 of the thermal component 215). The side of the thermal component can couple with a sidewall of multiple battery cells 120. For example, the side of the thermal component can couple with the sidewall of multiple prismatic battery cells. The thermal component 215 can cool one side of multiple battery cells 120. For example, the thermal component 215 can cool one side of multiple prismatic battery cells. The first side of the thermal component 215 can couple with the battery cell 120. The first side of the thermal component 215 can contact the sidewall of the battery cell 120.

The apparatus 300 can include at least one inlet 325. The inlet 325 can couple with the thermal component 215. For example, the inlet 325 can be disposed on the thermal component 215. The inlet 325 can be disposed on the first side 310 of the thermal component 215 or the second side 315 of the thermal component 215. The inlet 325 can have a variety of form factors, shapes, or sizes. The inlet 325 can receive coolant. The inlet 325 can include an opening to allow coolant to flow through the thermal component 215.

The apparatus 300 can include at least one outlet 330. The outlet 330 can couple with the thermal component 215. For example, the outlet 330 can be disposed on the thermal component 215. The outlet 330 can be disposed on the first side 310 of the thermal component 215 or the second side 315 of the thermal component 215. The outlet 330 can have a variety of form factors, shapes, or sizes. The outlet 330 can receive coolant. The outlet 330 can include an opening to allow coolant to flow through the thermal component 215. The outlet 330 can be fluidly coupled with the inlet 325. For example, coolant can flow from the inlet 325 to the outlet 330.

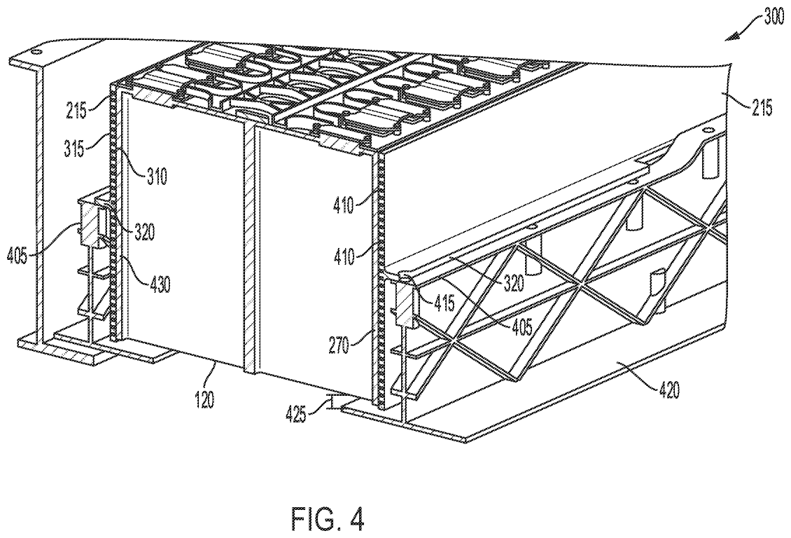

FIG. 4 depicts a perspective view of the apparatus 300. The apparatus 300 can include the thermal component 215. The thermal component 215 can include the first side 310 of the thermal component 215 and the second side 315 of the thermal component 215. The thermal component 215 can include the mounting member 320. The apparatus 300 can include a structural member 405. The apparatus 300 can include the battery cell 120.

The mounting member 320 can couple with the structural member 405. For example, the mounting member 320 can be disposed on the structural member 405. The mounting member 320 can rest on or interface with the structural member 405. The mounting member 320 can interlock with the structural member 405. The second side 315 of the thermal component 215 can couple with the structural member 405. The structural member 405 can support the battery cell 120. For example, the structural member 405 can support the weight of the battery cell 120. The structural member 405 can support the weight of the battery cell 120 through the mounting member 320. The mounting member 320 can transfer the load of the battery cell 120 to the structural member 405. The mounting member 320 can separate the sidewall 270 of the battery cell 120 from the structural member 405. The structural member 405 can be coupled with the thermal component 215 via the mounting member 320. For example, the structural member 405 can interface with the mounting member 320 and the mounting member 320 can interface with the thermal component 215.

The apparatus 300 can include at least one base member 420. The structural member 405 can couple with the base member 420. For example, the structural member 405 can be disposed on the base member 420. The structural member 405 and the base member 420 can be a unitary piece. The base member 420 can be separated from the battery cell 120 by a distance 425. The battery cell 120 can be supported by the mounting member 320 such that the battery cell 120 does not contact the base member 420. The structural member 405 can support the weight of the battery cell 120 such that the battery cell 120 is removed from the base. The base 420 can be disposed under the battery cell 120. The base 420 can be disposed under the structural member 405.

The structural member 405 can include a first structural member 405. The first structural member 405 can couple with the mounting member 320. The apparatus 300 can include a second structural member 405. The second structural member 405 can couple with the mounting member 320. The mounting member 320 can be disposed between the first structural member 405 and the second structural member 405. For example, the mounting member 320 can be disposed below the first structural member 405 and above the second structural member 405. The mounting member 320 can be disposed above the first structural member 405 and below the second structural member 405. The mounting member 320 can separate the first structural member 405 and the second structural member 405.

The battery cell 120 can be disposed between the first structural member 405 and the second structural member 405. For example, the battery cell 120 can be disposed on a first side of the first structural member 405 and on a first side of the second structural member 405. The first structural member 405 can be disposed on a left side of the battery cell 120 and the second structural member 405 can be disposed on a right side of the battery cell 120. The first structural member 405 can be disposed on a right side of the battery cell 120 and the second structural member 405 can be disposed on a left side of the battery cell 120.

The mounting member 320 can include at least one recess 415. For example, the mounting member 320 can include the recess 415 disposed on the mounting member 320. The recess 415 can receive an alignment pin. For example, the recess 415 can receive the alignment pin of the structural member 405. The alignment pin can couple the mounting member 320 with the structural member 405. For example, the alignment pin can secure the mounting member 320 to the structural member 405. The mounting member 320 can include at least one aperture. The aperture can receive alignment pin. For example, the aperture can receive the alignment pin of the structural member 405.

The apparatus 300 can include a flange. For example, the mounting member 320 can include the flange. The mounting member 320 can include a protruded ridge, lip, or rim that allows the mounting member 320 to couple with the structural member 405. The structural member 405 can include the flange. The structural member 405 can include a protruded ridge, lip, or rim that allows the structural member 405 to couple with the mounting member 320. The flange can maintain the position of the mounting member 320 on the structural member 405. The flange can couple the mounting member 320 with the structural member 405.

The apparatus 300 can include at least one channel 410. The channel 410 can be disposed in the thermal component 215. For example, the channel 410 can be located in an interior of the thermal component 215. The channel 410 can disperse coolant throughout the thermal component 215. The inlet 325 can be fluidly coupled with the channel 410. The inlet 325 can receive the coolant. The outlet 330 can be fluidly coupled with the channel 410. The outlet 330 can release the coolant. The channel 410 can include a series of switchbacks within the thermal component 215. The channel 410 can be disposed along the length of the thermal component 215. The channel 410 can include can include multiple inlets 325 and outlets 330. The channel 410 can be continuous or discontinuous. Multiple channels 410 can be disposed in the thermal component 215.

The thermal component 215 can include a first thermal component 215. The sidewall 270 can include a first sidewall 270. The mounting member 320 can include a first mounting member 320. The structural member 405 can include a first structural member 405. The apparatus 300 can include a second thermal component 215. The second thermal component 215 can include a first side 310 of the second thermal component 215. The second thermal component 215 can include a second side 315 of the second thermal component 215. The first side 310 of the second thermal component 215 can couple with a second sidewall 430 of the battery cell 120. The second sidewall 430 and the first sidewall 270 can be disposed on opposite sides of the battery cell 120. For example, the second sidewall 430 can be disposed on a right side of the battery cell 120 and the first sidewall 270 can be disposed on a left side of the battery cell. The second sidewall 430 can be disposed on a left side of the battery cell 120 and the first sidewall 270 can be disposed on a right side of the battery cell. The second sidewall 430 and the first sidewall 270 can be disposed on opposite sides of the battery cell 120 in a cell-to-pack configuration. The second side 315 of the second thermal component 215 can include a second mounting member 320. The second mounting member 320 can couple with the second structural member 405. The second structural member 405 can support the battery cell 120.

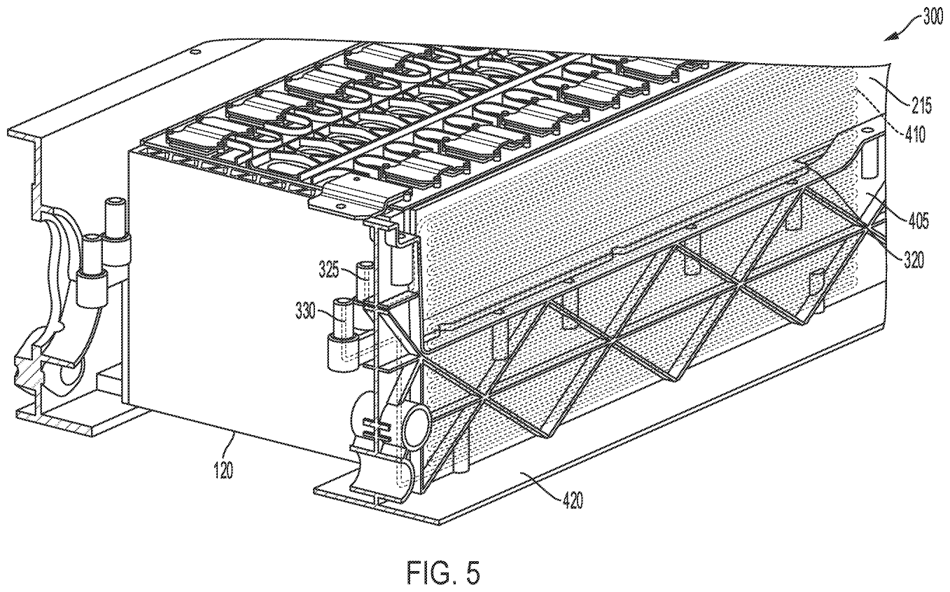

FIG. 5 depicts a perspective view of the apparatus 300. The apparatus 300 can include the thermal component 215. The apparatus 300 can include the mounting member 320. The apparatus 300 can include the inlet 325. The apparatus 300 can include the outlet 330. The apparatus 300 can include the structural member 405. The apparatus 300 can include the channel 410. The apparatus 300 can include the base 420. The apparatus 300 can include the battery cell 120.

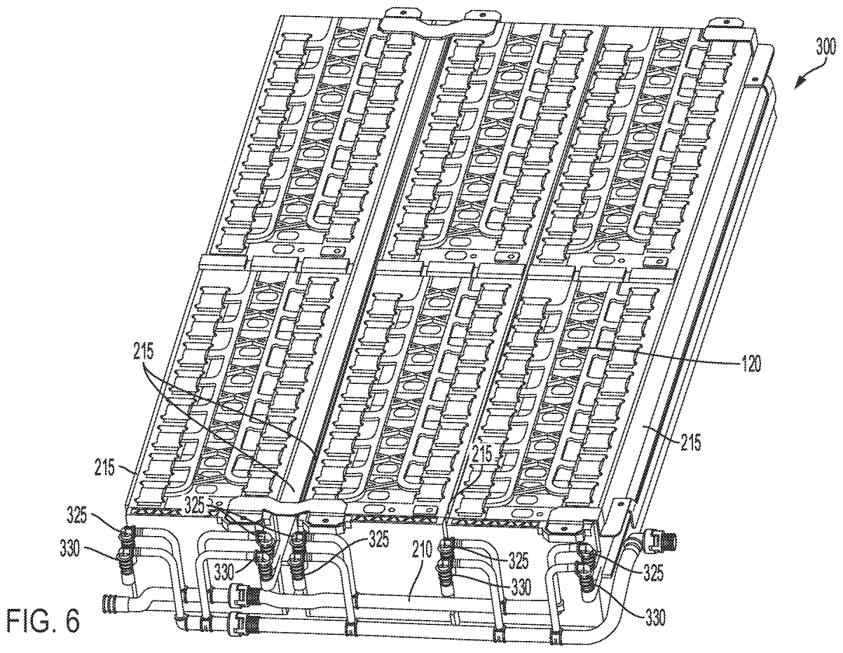

FIG. 6 depicts a perspective view of the apparatus 300. The apparatus 300 can include the thermal component 215. The apparatus 300 can include the mounting member 320. The apparatus 300 can include the inlet 325. The apparatus 300 can include the outlet 330. The apparatus 300 can include the structural member 405. The apparatus 300 can include the channel 410. The apparatus 300 can include the base 420. The apparatus 300 can include the cooling line 210. The apparatus 300 can include the battery cell 120.

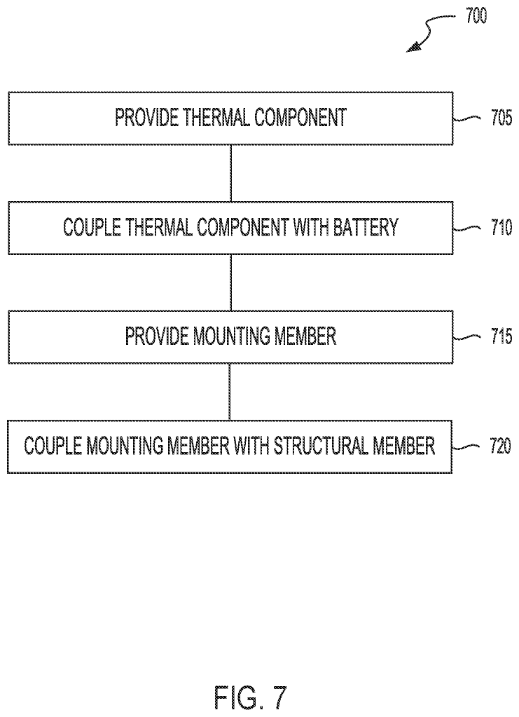

FIG. 7 depicts a method 700 of managing the temperature of battery cells and supporting the battery cells. The method 700 can include providing the thermal component (ACT 705). The method 700 can include coupling the thermal component with the battery (ACT 710). The method 700 can include providing the mounting member (ACT 715). The method 700 can include coupling the mounting member with the structural member (ACT 720).

The method 700 can include providing the thermal component (ACT 705). For example, the method 700 can include providing the thermal component including the first side of the thermal component and the second side of the thermal component. The thermal component can cool the battery cell. The thermal component can heat the battery cell. The thermal component can be flat or substantially flat. The thermal component can have a variety of form factors, shapes, or sizes. The thermal component can be positioned relative to the first battery cell and the second battery cell. The first battery cell can be disposed on the side of the second battery cell. The thermal component can be positioned between the first battery cell and the second battery cell. The first battery cell, the second battery cell, and the thermal component can be positioned along a horizontal axis or a vertical axis. The thermal component can be disposed relative to the first battery module and the second battery module. The first battery module can be disposed on a side of the second battery module. The thermal component can be position in between the first battery module and the second battery module. The first battery module, the second battery module, and the thermal component can be positioned along a horizontal axis or a vertical axis.

The thermal component can include a second side of the thermal component. The second side of the thermal component can be disposed opposite the first side of the thermal component. For example, the second side of the thermal component can be located on a side of thermal component that that is opposite the first side of the thermal component. The second side of the thermal component can be flat or substantially flat. The second side of the thermal component can include a protrusion, depression, or recess.

The method 700 can include coupling the thermal component with the battery (ACT 710). For example, the method 700 can include coupling the first side of the thermal component with the sidewall of the battery cell. The thermal component can include the first side of the thermal component. The first side of the thermal component can couple with at least one sidewall of at least one battery cell. For example, the first side of the thermal component can couple with the sidewall of multiple battery cells. The first side of the thermal component can interface with the sidewall of multiple battery cells. The first side of the thermal component can interface with multiple sidewalls of multiple battery cells. The first side of the thermal component can couple with the sidewall of multiple battery cells contained in the battery module. The first side of the thermal component can couple with the battery module. The first side of the thermal component can couple with the plurality of sidewalls of battery cells. The first side of the thermal component can be flat or substantially flat. The method 700 can include coupling the second side of the thermal component with the structural member 405.

The method 700 can include providing the mounting member (ACT 715). For example, the method 700 can include providing the mounting member disposed on the second side of the thermal component. The method 700 can include disposing the mounting member proximate the center of gravity of the battery cell. For example, the mounting member can be positioned at the center of gravity of the battery cell. The thermal component and the mounting member can be a unitary piece. For example, the thermal component and the mounting member can be made from a single piece of material. The mounting member can be disposed along a midline of the thermal component. For example, the midline of the thermal component can bisect the thermal component into a top portion of the thermal component and a bottom portion of the thermal component. The mounting member can be positioned along the midline of the thermal component. The mounting member can include a protrusion, depression, or recess. The mounting member can be disposed along a portion of the thermal component.

The method 700 can include coupling the mounting member with the structural member (ACT 720). For example, the method 700 can include coupling the mounting member with the structural member. The mounting member can rest on or interface with the structural member. The mounting member can interlock with the structural member. The second side of the thermal component can couple with the structural member. The structural member can support the battery cell. For example, the structural member can support the weight of the battery cell. The structural member can support the weight of the battery cell through the mounting member. The mounting member can transfer the load of the battery cell to the structural member. The mounting member can separate the sidewall of the battery cell from the structural member. The structural member can be coupled with the thermal component via the mounting member. For example, the structural member can interface with the mounting member and the mounting member can interface with the thermal component.

The structural member can include the first structural member. The method 700 can include coupling the mounting member with the second structural member. The mounting member can be disposed between the first structural member and the second structural member.

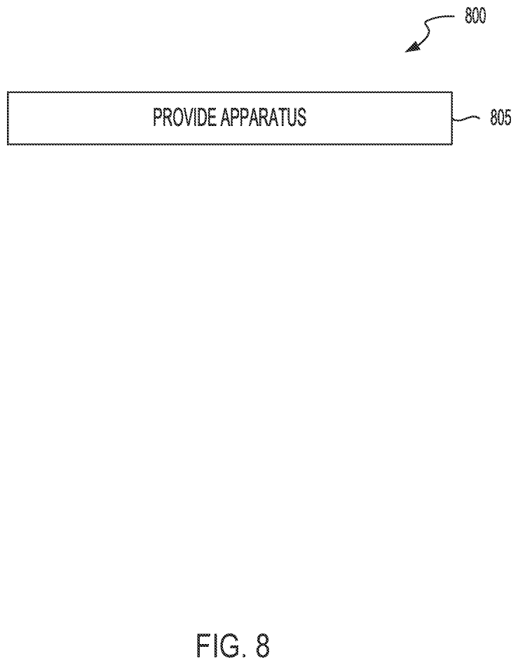

FIG. 8 depicts a method 800 of providing the apparatus. The method 800 can include providing the apparatus (ACT 805). The apparatus can include the thermal component. The thermal component can include the first side of the thermal component. The thermal component can include the second side of the thermal component. The first side of the thermal component can couple with the sidewall of a battery cell. The second side of the thermal component can include the mounting member. The mounting member can couple with the structural member. The structural member can support the battery cell.

The electric vehicle can include a battery pack. The battery pack can power one or more components of the electric vehicle. The electric vehicle can include a battery cell disposed in the battery pack. The electric vehicle can include a thermal component. The thermal component can include a first side of the thermal component and a second side of the thermal component. The first side of the thermal component can couple with a sidewall of the battery cell. The electric vehicle can include a mounting member disposed on the second side of the thermal component. The electric vehicle can include a structural member. The structural member can couple with the second side of the thermal component. The structural member can support the battery cell.

The electric vehicle can include a battery cell disposed in a battery module. The first side of the thermal component can couple with a sidewall of the battery module. The structural member can include a first structural member. The first structural member can couple with a first base member. The electrical vehicle can include a second structural member. The second structural member can couple with a second base member. The first structural member and the second structural member can be disposed on opposite sides of the battery cell. The second sidewall and the first sidewall can be disposed on opposite sides of the battery cell in a cell-to-pack configuration. The mounting member can be disposed between the first structural member and the second structural member. The electric vehicle can include a base member. The base member can couple with the structural member. The battery cell can be located a distance from the base member.

The system can include a battery cell. The battery cell can include a sidewall. The system can include a thermal component. The thermal component can include a first side of the thermal component and a second side of the thermal component. The first side of the thermal component can couple with the sidewall of the battery cell. The second side of the thermal component can include a mounting member. The mounting member can couple with a structural member. The structural member can support the battery cell.

The electric vehicle can include a battery cell disposed in a battery pack frame. The electric vehicle can include a thermal component. The thermal component can include a first side of the thermal component and a second side of the thermal component. The first side of the thermal component can couple with a sidewall of the battery cell. The electric vehicle can include a mounting member disposed on the second side of the thermal component. The electric vehicle can include a structural member. The structural member can couple with the mounting member. The electric vehicle can include a base member. The base member can couple with the structural member. The base member can be disposed a distance from a midline of the battery pack frame.

The apparatus can include a thermal component. The apparatus can include a first side of the thermal component. The first side of the thermal component can couple with a sidewall of a battery cell. The apparatus can include a second side of the thermal component. The second side of the thermal component can include a mounting member. The mounting member can couple with a structural member. The structural member can support the battery cell.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. An apparatus, comprising:
a thermal component comprising a first side of the thermal component and a second side of the thermal component disposed opposite the first side of the thermal component;
the first side of the thermal component configured to couple with a sidewall of a battery cell;
the second side of the thermal component configured to couple with a structural member, the structural member configured to support a weight of the battery cell;
the second side of the thermal component comprising a mounting member;
a channel disposed in the thermal component;
the channel configured to couple with an inlet to receive coolant;
the channel configured to couple with an outlet to release the coolant;
the mounting member comprising a flange oriented substantially perpendicular to the thermal component and oriented substantially perpendicular to the sidewall of the battery cell; and
the flange configured to couple with the structural member.

2. The apparatus of claim 1, wherein the structural member is a first structural member, the apparatus comprising:
the mounting member configured to couple with the first structural member;
a second structural member configured to couple with the mounting member; and
the mounting member disposed between the first structural member and the second structural member.

3. The apparatus of claim 1, wherein the thermal component is a first thermal component, the structural member is a first structural member, the sidewall is a first sidewall, and the mounting member is a first mounting member, the apparatus comprising:
the first mounting member configured to couple with the first structural member;
a second thermal component comprising a first side of the second thermal component and a second side of the second thermal component;
the first side of the second thermal component configured to couple with a second sidewall of the battery cell;
the second sidewall and the first sidewall disposed on opposite sides of the battery cell in a cell-to-pack configuration; and
the second side of the second thermal component comprising a second mounting member, the second mounting member configured to couple with a second structural member, the second structural member configured to support the battery cell.

4. The apparatus of claim 1, comprising:
the battery cell comprising a prismatic cell; and
the thermal component configured to cool the prismatic cell in a cell-to-pack configuration.

5. (canceled)

6. The apparatus of claim 1, comprising:
the mounting member configured to couple with the structural member; and
the mounting member comprising a recess configured to receive an alignment pin of the structural member.

7. (canceled)

8. The apparatus of claim 1, comprising:
the mounting member disposed between a top portion of the battery cell and a bottom portion of the battery cell.

9. The apparatus of claim 1, comprising:
the thermal component and the mounting member are a unitary piece.

10. The apparatus of claim 1, comprising:
the first side of the thermal component configured to contact the sidewall of the battery cell.

11. The apparatus of claim 1, comprising:
the structural member configured to couple with a base member; and
the battery cell located a distance from the base member.

12. The apparatus of claim 1, comprising:
the mounting member disposed along a midline of the thermal component.

13. A method, comprising:
providing a thermal component comprising a first side of the thermal component and a second side of the thermal component disposed opposite the first side of the thermal component, the second side of the thermal component comprising a mounting member, the mounting member comprising a flange;
coupling the first side of the thermal component with a sidewall of a battery cell;
coupling the second side of the thermal component with a structural member, the structural member configured to support a weight of the battery cell;
disposing a channel in the thermal component;
fluidly coupling the channel with an inlet, the inlet configured to receive coolant;
fluidly coupling the channel with an outlet, the outlet configured to release the coolant; and
orienting the flange substantially perpendicular to the thermal component and substantially perpendicular to the sidewall of the battery cell, the flange configured to couple with the structural member.

14. The method of claim 13, wherein the structural member is a first structural member, the method comprising:
coupling the mounting member with a second structural member, the mounting member configured to be disposed between the first structural member and the second structural member.

15. The method of claim 13, comprising:
disposing the mounting member between a top portion of the battery cell and a bottom portion of the battery cell.

16. An electric vehicle, comprising:
a battery pack configured to power one or more components of the electric vehicle;
a battery cell disposed in the battery pack;
a thermal component comprising a first side of the thermal component and a second side of the thermal component disposed opposite the first side of the thermal component, the first side of the thermal component configured to couple with a sidewall of the battery cell;
a structural member configured to couple with the second side of the thermal component and configured to support a weight of the battery cell;
the second side of the thermal component comprising a mounting member;
a channel disposed in the thermal component;
the channel fluidly coupled with an inlet to receive coolant;
the channel fluidly coupled with an outlet to release the coolant; and
the mounting member comprising a flange oriented substantially perpendicular to the thermal component and oriented substantially perpendicular to the sidewall of the battery cell, the flange configured to couple with the structural member.

17. The electric vehicle of claim 16, comprising:
the battery cell disposed in a battery module.

18. The electric vehicle of claim 16, wherein the structural member is a first structural member, the electric vehicle comprising:
a second structural member; and
the mounting member disposed between the first structural member and the second structural member.

19. The electric vehicle of claim 16, comprising:
a base member configured to couple with the structural member; and
the battery cell located a distance from the base member.

20. The electric vehicle of claim 16, wherein the structural member is a first structural member, the electric vehicle comprising:
the first structural member configured to couple with a first base member;
a second structural member configured to couple with a second base member; and
the first structural member and the second structural member disposed on opposite sides of the battery cell.
